(19) United States
(12) Patent Application Publication
(10) Pub. No.: US 2004/0207121 A1
(43) Pub. Date: Oct. 21, 2004

(54) Process and apparatus for forming stress-free thermosetting resin products in one mold

(76) Inventor: Paul R. Schiller, West Vancouver (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/418,149

(22) Filed: Apr. 18, 2003

(51) Int. Cl. B29C 33/56

(52) U.S. Cl. 264/338; 249/115

(57) ABSTRACT

A process for forming a stress-free thermosetting product which comprises: (a) mixing a high impact polymer compound, a liquid thermosetting monomer, a low temperature polymerizing catalyst and a high temperature polymerizing catalyst together; (b) pouring the thermosetting monomer, high impact polymer compound mixture, a low temperature polymerizing catalyst and high temperature polymerizing catalyst into a cavity of a mold which has a polymer coating or film on the interior surface thereof; (c) permitting the mixture in the mold with the low temperature and high temperature polymerizing catalysts to cure to a fully cured polymerized product; and (d) removing the polymerized product from the mold and stripping away the coating or film.

### FIELD OF THE INVENTION

This invention is directed to a novel method and apparatus for casting stress-free thermosetting resin materials in one mold, without requiring subsequent treatment in a curing oven.

### BACKGROUND OF THE INVENTION

Over the years, thermosetting polymer products of various types have been produced by a wide variety of processes and apparatus, ranging from free mold pouring of resin with fillers to double enclosed molds where the polymer material is heated in the mold and after polymerization, the mold is opened to produce a finished molded product. In some cases, subsequent curing of the molded product in an oven is required.

One type of molded product, kitchen sinks, vanity tops, counter tops, and the like, formed from polymerized thermosetting resins, have been produced for many years using various types of molds and processes. Typically, the thermosetting polymer, such as a polyester, or a polyacrylate, is formed in a mold, and cured in the mold to produce the finished product. A problem with this technique is that the thermosetting resins tend to shrink as they cure, particularly during the final stages of cure. The shrinking process, while the curing reaction proceeds to completion, creates latent stresses in the finished product. These latent stresses create invisible current or future microscopic fissures in the body and surfaces of the finished thermoset products. These latent stresses and microscopic fissures and crazes cause a problem when the cast products are used as kitchen sinks, vanity tops, countertops and the like, wherein the surfaces are exposed to mild caustic and acidic cleaning chemicals, in the form of surface cleaning compounds, detergents, soaps, bleaches and polishes.

Another problem, particularly prevalent with kitchen sinks, and the like, is that the thermoset material is subjected to sudden thermal shock (sudden contraction or expansion) caused by exposure to hot or cold water when the hot or cold water taps are turned on. The microfissures become aggravated under such treatment, and eventually enlarge to the point that visible cracks occur. Eventually, the fixture becomes so unsightly that it must be replaced.

A further problem is that when the thermosetting polymer shrinks as it cures, the surface of the polymer tends to delaminate from the face of the mold. The surface then oxidizes and loses its shine. This detracts from the appearance of the fixture. To prevent delamination, force must be applied to the back of the mold to hold it against the polymer.

The American National Standard for Plastic Laboratories (ANSI) has a number of standard tests which must be passed in order for a particular lavatory product to be commercially acceptable. One test, ANSI Z124.3, Section 6.3, requires, among other things, that the lavatory unit be subjected to thermal shock exposure by having the product endure at least 500 cycles of hot and cold water. Each cycle consists of 1.5 minutes of 150° F. (65° C.) water flowing at a rate of 1 Imp. gal./minute (4 litres/minute), followed by a 30 second drain. The product is then exposed to 1.5 minutes of 50° F. (10° C.) water flowing at 1 Imp. gal./minute (4 litres/minute). No crazing, cracking, blistering or spalling must be visible in the product at the conclusion of 500 cycles.

German Patent No. 29 22 675, Karl Schock, issued Jan. 29, 1981, discloses a process of making articles of mineral filled acrylic resin. The articles include kitchen sinks, vanity tops and a variety of similar products. In the Schock process, it is mentioned that the material is poured into a closed mold. During the polymerization process, the polymer shrinks. To accommodate this, a force is applied to one component of the mold to compensate for the shrinkage of the polymer material as it cures. The material is polymerized to completion in the mold, after which the mold is opened and the finished cured product is removed.

German Patent No. 371295 A1 describes a process whereby a first layer of polymer material is poured into a mold as first coating. At a later stage, the same or another polymer material is poured into the mold as reinforcement.

U.S. Pat. No. 4,652,596, Williams et al., granted Mar. 24, 1987, discloses a process for producing cast unsaturated thermosetting resins which are purportedly highly stain resistant. A pressurization step is applied to the thermosetting resin prior to casting to reincorporate any monomer which has volatilized during a previous vacuum deaeration step. The resultant casting is non-porous in cross-section which produces a product which is both stain resistant and machinable in the field without exposing voids.

U.S. Pat. No. 4,473,673, granted Sep. 25, 1984, Williams et al., describes a method in which basic resins are mixed with mineral filler in a vacuum process to densify the mixture before it is poured into a mold. The mold is then vibrated to accommodate the material and avoid air entrapments.

U.S. Pat. No. 5,407,627, issued Apr. 18, 1995, Schiller et al., discloses a novel method and apparatus for casting stress-free thermosetting resin materials. The process for forming a thermosetting product comprises: (a) pouring a thermosetting polymer, with initiator, and catalyst, into a cavity of a mold which has a polymer coating or film on the interior surface thereof; (b) permitting the polymer to cure to a point where the cured material is reasonably dimensionally stable; (c) removing the partially cured polymeric material from the mold and placing the material in an oven; and (d) fully curing the polymeric material in the oven.

A problem with this process is that the partially cured polymer product must be removed from the mold, and transferred to the curing oven. This step slows production time. Also, the partially cured polymer can warp or be damaged in transfer to an oven for post cure.

### SUMMARY OF THE INVENTION

The subject invention relates to a novel method of molding in one step stress-free products from thermosetting polymeric materials, which are either unfilled or filled with filler such as fibreglass or mineral fillers. The stress-free thermosetting thermoshock resistant materials are molded for the manufacture of kitchen sinks, vanity tops, bowls, countertops and furniture parts. The one-step molded products are virtually stress free and are therefore highly resistant to thermoshock exposure, or attack by mildly caustic or acidic cleaning compounds, and the like.

In one aspect, the invention is directed to a process and apparatus of producing in one continuous operation in one mold a non-porous cast thermosetting acrylic polymeric material, either homogenous or filled with fibreglass or mineral reinforcement, or combinations thereof, which has little or no latent stress in the finished molded article.

In general terms, the invention is directed to a process for forming a thermosetting product which comprises: (a) mixing a powderized high impact stress absorbing polymer compound with a liquid thermosetting monomer; (b) mixing the thermosetting monomer and the high impact polyacrylate compound mixture, with a low temperature polymerizing catalyst and a high temperature polymerizing catalyst to form a liquid mixture; (c) pouring the mixture into a cavity of a mold which has a polymer release coating or film on the interior surface of the mold; and (d) polymerizing the mixture in the mold to a fully cured polymerized product.

The liquid monomer can be an acrylic monomer selected from the group consisting of methylmethacrylate, n-butylmethacrylate, n-hexylmethacrylate, n-butylacrylate, 2-ethylhexylacrylate, 2-ethylhexylmethacrylate, ethyleneglycoldimethacrylate, triethyleneglycoldimethacrylate and trimethylolpropanate, or a mixture of these monomers. The powderized polymer compound can be a polyacrylate formed from an acrylic monomer selected from the group consisting of methylmethacrylate, n-butylmethacrylate, n-hexylmethacrylate, n-butylacrylate, 2-ethylhexylacrylate, 2-ethylhexylmethacrylate, ethyleneglycoldimethacrylate, triethyleneglycoldimethacrylate and trimethylolpropanate, or a mixture of these monomers.

A low temperature polymerization initiator can be added to the mixture and selected from the group consisting of a zinc, cadmium, cobalt, copper or an iron substituted organic substance or from the group consisting of zinc thioglycol, cadmium thioglycol, cobalt naphthenate, iron naphthenate, and copper naphthenate, or a compound selected from the group consisting of 2-aminopropanol, D-alatinol, 1-phenylethanol, dimethyl-p-toluidine, di(2-hydroxy-ethyl)p-toluidine, dimethylaniline and t-butylperoxy-2-ethylhexanoate.

The low temperature catalyst can be selected from the group consisting of lauryl peroxide, benzoyl peroxide, hydroperoxide, alkylperoxide, dibenzoyl peroxide, t-butyl peroctoate, t-butylperoxybenzoate, perbenzoate, perpivalate, permaleinate azobis-isobutyl acetate, azobis-isobutyl nitrile, butyl permaleinate peroxide, alkyd sulfhydride ester, monoperoxycarbonate and diperoxyketal.

The liquid monomer can be methylmethacrylate. The polymerized high impact polymer compound can be a polymerized n-butylmethacrylate. The catalyst can be a methyleneglycolthioacid ester. The monomer can be a mixture of methylmethacrylate and n-hexylmethacrylate. The catalyst can be lauryl peroxide and benzoyl peroxide.

The polymer film can be selected from the group consisting of polyethylene film, polyvinylchloride film, polyvinyl acetate film, polyvinyl alcohol film or Teflon film. The polymer coating can be a sprayed polyvinyl alcohol.

The catalytic action of the low temperature catalyst can promote the polymerization of the polymer material to about 80 to 95% completion, and a temperature of about 70° C., and the high temperature catalyst can promote the polymerization of the partially cured material to 100% completion. The mold can be constructed of a material selected from the group consisting of polyester resin, epoxy resin, steel and aluminum.

The invention is also directed to a mold for forming a polymerized product comprising: (a) a female component which has formed therein one portion of a mold cavity; (b) a male component which has formed therein a complementary portion of a mold cavity, the male component being adapted to engage the female component so that a complete mold cavity is formed between the two components; and (c) a flexible polymeric film or coating covering at least one interior surface of the mold cavity when the male and female mold components are engaged.

Alternatively, the interior surface of the mold cavity can be coated with a removable polymeric coating. The female and male components of the mold can be formed of polished aluminum, and the polymeric film material can be formed of a polymer selected from the group consisting of polyethylene film, polyvinyl chloride film, polyvinyl-polyvinylidene film and polyvinyl alcohol film.

### BRIEF DESCRIPTION OF THE DRAWINGS

In drawings which illustrate specific embodiments of the invention but which should not be construed as restricting the spirit or scope of the invention in any way:

FIG. 1 represents a schematic end section exploded view of the two components of a two-part mold forming a mold cavity.

FIG. 2 represents a schematic end section view of a two-part mold with the two parts closed together and a polymeric film covering the walls of the interior cavity formed by the two parts.

FIG. 3 illustrates a schematic end section view of the two part mold after being opened, with the two mold parts separated and the 100% cured polymeric material being removed from the mold.

FIG. 4 illustrates a graphical plot of polymerization temperature vs. degree of polymer cure.

### DETAILED DESCRIPTION OF THE INVENTION

The process and apparatus of the invention produces in one continuous operation in the mold a non-porous thermosetting substantially stress-free polymeric cast article, either homogenous unfilled, or filled with reinforcing material such as fibreglass, or mineral fillers, or combinations thereof. The cast article is virtually free of latent stresses which are prone to attack by mildly alkaline or acidic cleaning materials or crazing or microfissure development due to thermoshock caused by hot or cold temperatures. Suitable casting materials can be thermosetting polyesters, epoxies or acrylics. As a general rule, for lavatory or kitchen fixtures, polyacrylics are preferred because for these fixtures they generally possess superior properties compared to polyesters and epoxies. Suitable acrylic monomers are methylmethacrylate and butylmethacrylate or ethylmethacrylate, n-butylmethacrylate, dimethacrylate, or a mixture of methacrylates.

A low temperature catalyst is used to initiate either a cold starting process or a hot process. The objective of the low temperature catalyst is to initiate and produce a partially polymerized acrylic product in the closed mold at a temperature starting at about room temperature (20° C.) and up to about 70° C. without having to apply any pressure to the mold or the polymerized product in order to prevent delamination. A polymer film lining or release coating in the mold cavity is used to assist separation of the cured polymer product from the mold, after full cure of the polymer product. The lining contacts the exterior surfaces of the acrylic polymer product, and shrinks about 2 to 5% along with the polymer product as it cures to about 80% to 95% cure, at a temperature of up to about 70° C. At that stage, the high temperature catalyst takes effect and the semi-polymerized acrylic product is further polymerized to 100%.

A deficiency with the process disclosed in U.S. Pat. No. 5,407,627 is that when the initial cure is conducted without pressure to about 92 or 94% completion, and the partially cured product is then moved to an oven where the final 6 or 8% cure is performed, which slows production time. Most of the 2 to 5% shrinkage in the cured product occurs during the final 6 to 8% cure of the polymer material. This was disclosed in U.S. Pat. No. 5,407,627. The partially cured product is still sufficiently flexible that it can warp or deform after being removed from the mold for transfer to the oven. While the internal latent stresses that are developed during the shrinkage are permitted to dissipate in the curing oven, thereby giving a finished molded product which is virtually free of latent stresses, the partially cured product can nonetheless deform, sag or warp when it is transferred to the oven, due to any one of a number of factors, including effect of gravity or uneven heating. The advantageous result of the process disclosed in U.S. Pat. No. 5,407,627 is that the finished product is not prone to developing hairline cracks, crazes or enlarged fissures which are commonplace with most thermosetting polymer materials when the surface of the finished product is treated with mildly alkaline or caustic cleaning materials, soaps, detergents, bleaches, polishes, or exposure to thermoshock caused by cyclic exposure to hot and cold water.

The subject invention overcomes these deficiencies and the problem of deformation after removal from the mold and transfer to the oven by retaining the polymer product in the mold to full cure. We have discovered that by incorporating about 5 to 30% weight of a powdered stress absorbing polyacrylate compound in the monomer and catalyst mixture, the incorporated compound absorbs internal stresses and the molded product can be retained to full cure in the mold, with minimal creation of internal stresses. The liquid monomer is thin and has a viscosity that resembles water. After the powdered polymerized material is added to the liquid monomer, the combined mixture is much thicker and has a viscosity similar to honey. The mold that can be used in the instant process can be constructed of polyester resin, epoxy resin, stainless steel, nickel coated steel, or aluminum. Aluminum is preferred because it is relatively inexpensive. The cavity is highly polished to minimize surface inconsistencies, and provide an attractive highly polished surface on the molded products.

We have also discovered that by using both a low temperature catalyst which promotes polymerization to about 80 to 95% completion and a high temperature catalyst which promotes full polymerization, build-up of internal stresses in the molded product is minimized.

The mold comprises a female and a male component, which cooperate with one another and when closed provide a cavity between the two components. The mold cavity in which the final product is to be molded is first covered with a flexible polymeric film or sheet. The flexible release film can be either sprayed on the surfaces of the mold, or layered into the mold. Suitable films or layering materials are polyethylene film, polyvinylchloride film, polyvinyl-polyvinylidene film, polyacrylic film, polyvinyl alcohol film or Teflon film. Once the mold cavity is covered with the desired film, the mold is closed. The uncured acrylic polymer material, which can either be homogenous or include reinforcing material, such as fibreglass, or mineral filler, or combinations thereof, together with appropriate peroxide activators and catalysts, is poured into the mold cavity through a small opening.

The polymeric raw material, comprising monomer, dissolved powdered polymer and appropriate catalysts, after being poured or injected into the mold, is prompted by the low temperature catalyst in the mixture to cure to about 80 to 95% of the full cure. The temperature of the partially cured polymer in the mold at this point has reached about 70° C. This generally takes about 30 minutes from the time the mixture was first poured in the mold. Then, at about 70° C., the high temperature catalyst becomes active and the 80 to 95% cured molded polymer material with the protective film around the exterior surface of the product continues to full cure of 100%. While it is true that the fully curing polymer does most of its shrinking in the last stages of cure and thereby develops inherent stresses in the product, we have discovered that the high impact polymer compound that is incorporated in the liquid monomer provides sufficient resiliency in the overall polymer product in the final cure stage that the development and build-up of internal stresses is absorbed or minimized. Thus a relatively stress-free polymer product is produced.

After the 100% cure stage has been reached, the latent stresses which are caused by the shrinkage of the fully curing polymeric material are absorbed by the high impact polymer compound in the mixture and the stresses tend to be relieved and dissipate, thereby minimizing the creation of microscopic fissures and crazes in the fully cured polymer material, due to shrinkage.

After the cured material is removed from the mold, the protective film(s) are carefully stripped from the mold and all protruding edges are then trimmed. At this stage, the product is ready for packaging for shipment.

FIG. 1 represents a schematic end section exploded view of a two-part male and female mold which when closed together form a mold cavity. As can be seen in FIG. 1, the two component mold 2 comprises a male component 4 with a protruding basin component, and a female component 6, with a recessed female basin component, which together create a cavity 8.

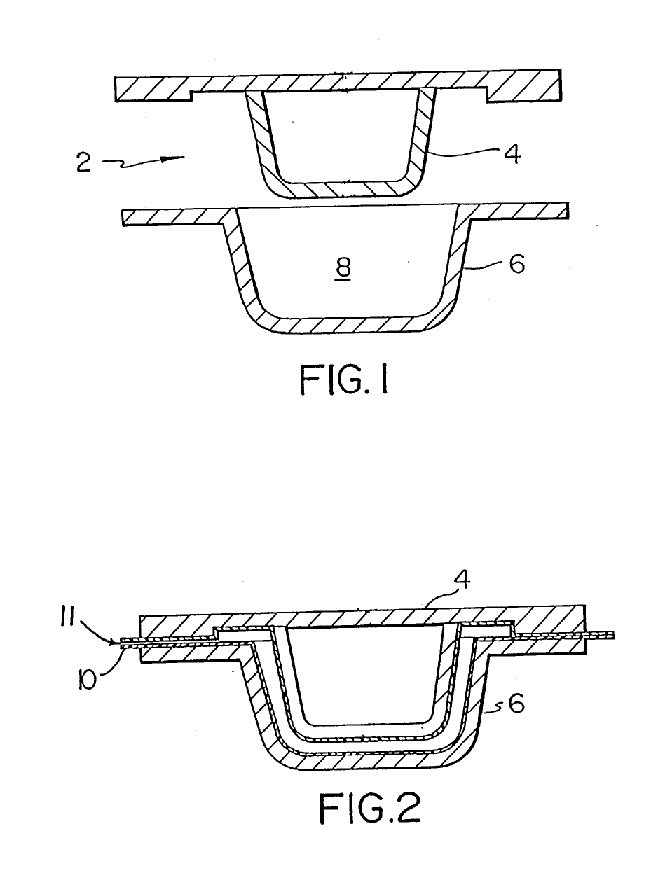

FIG. 2 represents a schematic end section view of the two parts of the mold assembled together and with a pair of polymeric films 10 in the interior thereof, covering both the male and female portions of the interior of the mold. The facing interior surfaces of the cavity 8 are lined with a respective pair of polymeric films 10, or alternatively can be coated with a flexible polymeric release coating which enables the cured polymer product to be released from the interior faces of the mold 2. The assembled two-part mold 2 is filled by injecting the liquid polymeric material mixture which is to be cast into the mold 2. Sufficient liquid polymer mixture is injected into opening 11 to completely fill the cavity between the two films 10.

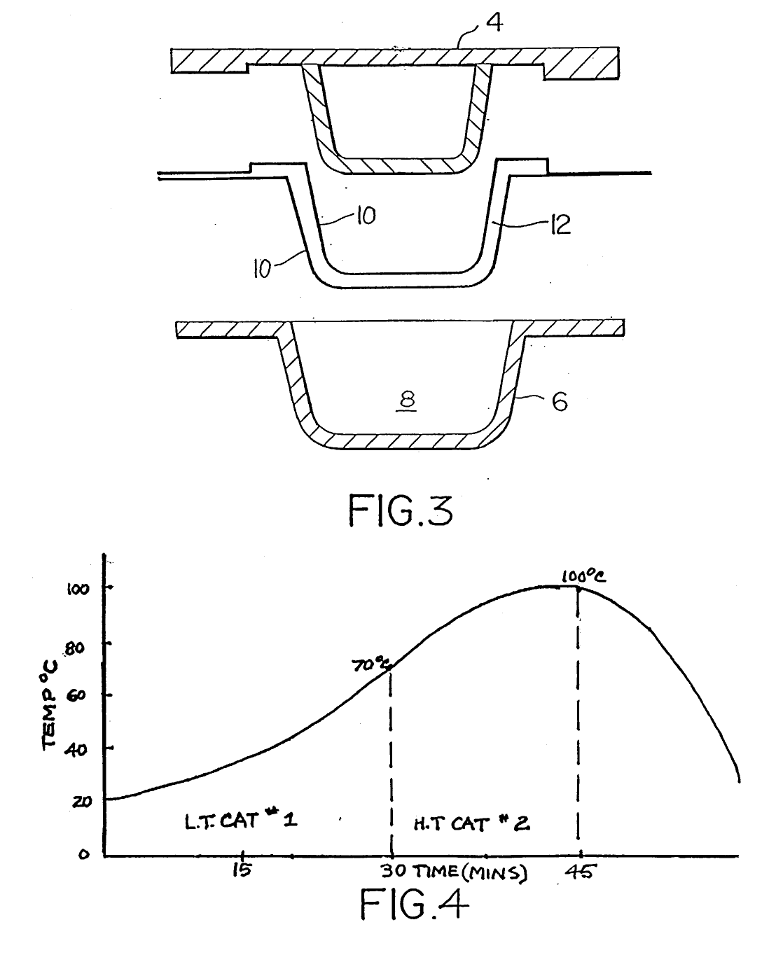

FIG. 3 illustrates a schematic exploded end view of the two part disassembled mold 2 with male component 4 and female component 6 separated from one another, and with the polymerized material 12, cured to 100% completion, removed from the mold. The polymeric film or coatings 10 cover both exterior faces of the cured product and are in effect shrunk around it, immediately after the mold is opened and the polymer 12 is removed from the mold 2. The two coatings 10 are carefully removed from the molded product 12 after the product 12 has cooled to about room temperature.

FIG. 4 illustrates a graphical plot of temperature (° C.) vs. time (minutes) of the curing process of the liquid monomer after it has been poured in a mold. The liquid monomer incorporating the high impact stress absorbing polyacrylic compound is poured in the mold at about room temperature of 20° C. The low temperature catalyst (L.T. Cat #1) promotes polymerization and since the polymerizing reaction is exothermic, the temperature of the curing polymer starts to rise to about 70° C. At that stage, the product may have cured to about 85 to 95% of complete polymerization. This first stage takes about 30 minutes. At a temperature of about 70° C., the high temperature catalyst (H.T. Cat #2) becomes active and promotes the polymerization process to complete 100% cure. This latter cure may take about 10 to 20 minutes.

The advantage of the thermoset substantially stress-free acrylic product according to the invention is that it is highly impact resistant, has low thermal conductivity (water stays warm in the container longer), is thermoshock resistant, and is not readily stained by tea bags, vegetable or fruit stains. The product has a non-porous hard surface and is ideally suited for construction of lavatory fixtures. Any scratches, cigarette burns, or stains which do form in the surface of the cast acrylic product can be readily removed with conventional household abrasive cleaners and a damp cloth.

### EXAMPLE

80 grams of methylmethacrylate, 5 grams of high impact n-butyl methacrylate compound, 200 grams of aluminum trihydrate pigment, 5 grams of silica powder, 0.5 grams of low temperature t-butylperoxy-2-ethylhexanoate catalyst, and 0.5 grams of high temperature catalyst, t-butyl-peroxybenzoate, were poured into the polished cavity of an aluminum mold, which had been lined with polyalcohol film release agent. The cavity of the mold was shaped to form a double sink. The material in the cavity of the mold started to generate heat and the cure proceeded for about 30 minutes to about 70%. Subsequently, the polymerizing continued to 100% cure. The mold was opened and the fully cured polymeric material, with the film around the exterior surface, was removed from the mold. After removal from the mold, the cast material was stripped of all film. The resulting molded product was a very attractive, smooth, polished surface, acrylic double sink.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A process for forming a stress-free thermosetting product which comprises:
(a) mixing a powderized thermosetting polymer compound, a liquid thermosetting monomer, a low temperature polymerizing catalyst and a high temperature polymerizing catalyst together to form a mixture;
(b) pouring the liquid thermosetting monomer, high impact compound, low temperature polymerizing catalyst and high temperature polymerizing catalyst mixture into a cavity of a mold which has a polymer coating or film on an interior surface thereof;
(c) polymerizing the mixture in the mold to a fully cured polymerized product, the low temperature polymerizing catalyst promoting polymerization of the mixture to about 80 to 95% cure completion at a temperature of about 70° C. and the high temperature polymerizing catalyst promoting polymerization of the mixture to 100% cure; and
(d) removing the fully cured polymerized product from the mold and stripping away the coating or film.

2. A process as defined in claim 2 wherein the powderized thermosetting polymer is a powderized polyacrylate and the monomer is an acrylic monomer.

3. A process as defined in claim 2 wherein the powderized polyacrylate is selected from the group consisting of polymethylmethacrylate, poly n-butylmethacrylate, poly n-hexylmethacrylate, poly n-butylacrylate, poly 2-ethylhexylacrylate, poly 2-ethylhexylmethacrylate, polyethyleneglycol-dimethacrylate, polytriethyleneglycol-dimethacrylate and polytrimethylolpropanate, or a mixture of these polymers.

4. A process as defined in claim 3 wherein the monomer is an acrylic monomer selected from the group consisting of methylmethacrylate, n-butylmethacrylate, n-hexylmethacrylate, n-butylacrylate, 2-ethylhexylacrylate, 2-ethylhexylmethacrylate, ethyleneglycol-dimethacrylate, triethyleneglycol-dimethacrylate and trimethylolpropanate, or a mixture of these monomers.

5. A process as defined in claim 1 wherein a polymerization initiator is added to the mixture and is selected from the group consisting of a zinc, cadmium, cobalt, copper or an iron substituted organic substance.

6. A process as defined in claim 4 wherein a polymerization initiator is added to the mixture and is selected from the group consisting of zinc thioglycol, cadmium thioglycol, cobalt naphthenate, iron naphthenate, copper naphthenate, or a compound selected from the group consisting of 2-aminopropanol, d-alatinol, 1-phenylethanol, dimethyl-p-toluidine, di(2-hydroxyethyl)p-toluidine.

7. A process as defined in claim 4 wherein the low temperature catalyst is selected from the group consisting of lauryl peroxide, benzoyl peroxide, hydroperoxide, alkylperoxide, dibenzoyl peroxide, dilauryl peroxide, t-butyl peroctoate, perbenzoate, perpivalate, permaleinate azobis-isobutyl acetate, azobis-isobutyl nitrile, butyl permaleinate peroxide, alkyd sulfhydride ester and t-butylperoxybenzoate.

8. A process as defined in claim 4 wherein the high temperature catalyst is selected from the group consisting of hydroperoxide, alkylperoxide, dibenzoyl peroxide, t-butyl peroctoate, perbenzoate, perpivalate, permaleinate azobis-isobutyl acetate, azobis-isobutyl nitrile, butyl permaleinate peroxide, t-butylperoxy-2-ethylhexanate, monoperoxycarbonate and diperoxyketal.

9. A process as claimed in claim 4 wherein high impact polyacrylate compound is poly n-butylmethacrylate.

10. A process as defined in claim 3 wherein the monomer is methylmethacrylate.

11. A process as defined in claim 3 wherein the monomer is a mixture of methylmethacrylate and n-butylmethacrylate.

12. A process as defined in claim 3 wherein the monomer is methylmethacrylate and the polymerized compound is poly n-butylmethacrylate.

13. A process as defined in claim 12 wherein the catalysts are t-butylpeoxybenzoate and t-butylperoxy-2-ethylhexanoate.

14. A process as defined in claim 1 wherein the polymer film is selected from the group consisting of polyethylene, polyvinylchloride, polyvinyl acetate film, polyvinyl alcohol film and Teflon film.

15. A process as defined in claim 1 wherein the polymer film is a sprayed polyvinyl alcohol which releases from the mold when the cured polymeric material is removed from the mold.

16. A process as defined in claim 1 wherein the mold is constructed of a material selected from the group consisting of polyester resin, epoxy resin, steel and aluminum.

17. A process as defined in claim 1 wherein a fibreglass or mineral reinforcement is added to the mixture before it is cured.

18. A process as defined in claim 7 wherein aluminum trihydrate pigment and silica powder are added to the mixture before curing.

19. A mold for forming a stress-free thermosetting polymerized product according to the process of claim 1 characterized by:
(a) a first mold component which has formed therein one portion of a mold cavity;
(b) a second mold component which has formed therein a complementary portion of a mold cavity, the second component being adapted to engage the first component so that a complete mold cavity is formed between the two components; and
(c) a release agent covering the interior surface of the mold cavity of the first component, and the interior surface of the mold cavity of the second component, so that the interior surfaces of the complete mold cavity, when the first and second mold components are engaged, the monomer, compound and catalysts being fully cured in the interior formed by the first component and the second component.

20. A mold as defined in claim 19 wherein the first and second components of the mold are formed of polished aluminum, and the release agent is formed of a substance selected from the group consisting of polyethylene, polyvinyl chloride, polyvinyl-polyvinylidene, polyvinyl alcohol and polyfluoroethylene (Teflon).

21. A mold as defined in claim 20 wherein the first and second components of the mold are reinforced.
